(19) United States
(12) Patent Application Publication
(10) Pub. No.: US 2025/0091634 A1
(43) Pub. Date: Mar. 20, 2025

(54) DECORATIVE BODY

(71) Applicant: KABUSHIKI KAISHA TOKAI-RIKA-DENKI-SEISAKUSHO, Niwa-gun, Aichi (JP)

(72) Inventor: Taichi HINO, Aichi (JP)

(21) Appl. No.: 18/291,742

(22) PCT Filed: Jul. 5, 2022
(86) PCT No.: PCT/JP2022/026749

§ 371 Date: Jan. 24, 2024

(30) Foreign Application Priority Data
Jul. 28, 2021 (JP) 2021-123640

(51) Int. Cl. B62D 1/06

(52) U.S. Cl. CPC B62D 1/06

(57) ABSTRACT

In a steering wheel, a thread portion of a self-tapping screw penetrates through a terminal of a harness and a skin layer of a conductive resin, and is inserted to an inside portion of the conductive resin. In a state in which a portion of the skin layer that the thread portion passes through is removed, the thread portion allows current to be conducted to the inside portion. Therefore, the terminal may conduct current to the inside portion, which has high conductivity, via the self-tapping screw, and conductivity from the harness to the conductive resin may be improved.

### TECHNICAL FIELD

The present invention relates to a decorative body in which a decorative member decorates a steering apparatus.

### BACKGROUND ART

In a steering wheel recited in Japanese Patent Application Laid-Open (JP-A) No. 2018-203061, a conductive member is disposed at an attached component, and the conductive member senses a vehicle occupant touching against the attached component.

In this steering wheel, if wiring conducts current to the conductive member, it is preferable to be able to improve conductivity from the wiring to the conductive member.

### SUMMARY OF INVENTION

### Technical Problem

In consideration of the circumstances described above, an object of the present invention is to provide a decorative body that may improve conductivity from wiring to a conductive resin.

### Solution to Problem

A decorative body according to a first aspect of the present invention includes: a decorative member provided at a steering apparatus of a vehicle, the decorative member decorating the steering apparatus; a conductive resin provided at the decorative member, the conductive resin being structured by molding of a resin into which a conductive material is mixed, and the conductive resin sensing a touch of a vehicle occupant against the decorative member; and a conductive portion provided at an inner side relative to a periphery portion of the conductive resin, the conductive portion conducting current from wiring in a state in which the periphery portion of the conductive resin is removed.

In a decorative body according to a second aspect of the present invention, the decorative body according to the first aspect of the present invention further includes a conductive member that is inserted into the conductive resin, removes the periphery portion of the conductive resin, and allows the wiring to conduct current to the conductive portion.

In a decorative body according to a third aspect of the present invention, in the decorative body according to the first or second aspect of the present invention, the steering apparatus includes a grip portion to be gripped by the vehicle occupant and a connecting portion that is connected to the grip portion, and the wiring is allowed to conduct current to the conductive portion in a connection region between the grip portion and the connecting portion.

In a decorative body according to a fourth aspect of the present invention, in the decorative body according to any one of the first to third aspects of the present invention, the wiring conducts current to the conductive portion in opposition to an urging force.

### Advantageous Effects of Invention

In the decorative body according to the first aspect of the present invention, the decorative member is provided at the steering apparatus of the vehicle, and the decorative member decorates the steering apparatus. The resin into which the conductive material is mixed is molded to structure the conductive resin of the decorative member. The conductive resin senses a vehicle occupant touching against the decorative member.

Because the resin into which the conductive material is mixed is molded to structure the conductive resin, the periphery portion of the conductive resin has a lower mix density of the conductive material and has lower conductivity.

Because the conductive portion is provided at the inner side relative to the periphery portion of the conductive resin, the wiring conducts current to the conductive portion in the state in which the periphery portion of the conductive resin is removed. Therefore, conductivity from the wiring to the conductive resin may be improved.

In the decorative body according to the second aspect of the present invention, the conductive member is inserted into the conductive resin, the peripheral portion of the conductive resin is removed, and the wiring is allowed to conduct current to the conductive portion. Therefore, the peripheral portion of the conductive resin may be removed and the wiring may conduct current to the conductive portion due to the insertion of the conductive member into the conductive resin. Thus, the wiring may conduct current to the conductive portion easily.

In the decorative body according to the third aspect of the present invention, the grip portion at which a vehicle occupant grips the steering apparatus and the connecting portion that is connected to the grip portion are provided.

Because the wiring conducts current to the conductive portion in the connection region between the grip portion and the connecting portion, the wiring may be easily routed at the connecting portion side.

In the decorative body according to the fourth aspect of the present invention, the wiring conducts current to the conductive portion in opposition to the urging force. Therefore, even when the conductive resin is deformed, conduction from the wiring to the conductive portion may be maintained by the urging force.

### BRIEF DESCRIPTION OF DRAWINGS

FIG. 1 is an elevation view, seen from a vehicle rear side, showing a steering wheel according to an exemplary embodiment of the present invention.

FIG. 2 is a sectional diagram showing conductive structures from a harness to a conductive resin in the steering wheel according to a first exemplary embodiment of the present invention.

### DETAILED DESCRIPTION

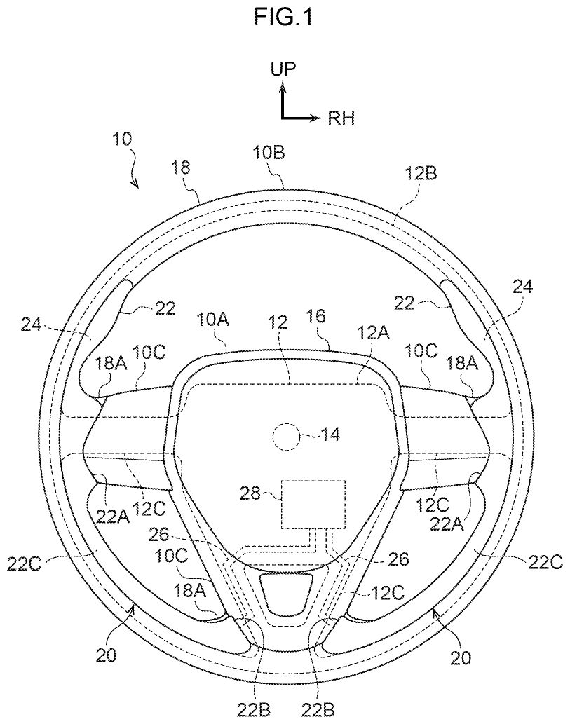

FIG. 1 is an elevation view, seen from a vehicle rear side, showing a steering wheel 10 that serves as a steering apparatus according to an exemplary embodiment of the present invention. In the drawings, a vehicle front side is indicated by arrow FR, a vehicle right side is indicated by arrow RH, and an upper side is indicated by arrow UP. The circumferential direction of the steering wheel 10 is indicated by arrow C and the radial direction outer side of the steering wheel 10 is indicated by arrow OUT.

The steering wheel 10 according to the present exemplary embodiment opposes a driver seat of the vehicle, which is at the vehicle rear side of the steering wheel 10. The steering wheel 10 is disposed to the vehicle front side of a vehicle occupant sitting on the driver seat (a driver, who touches the steering wheel 10).

As shown in FIG. 1, a boss portion 10A that serves as a supported portion is provided at a central region of the steering wheel 10. A rim section 10B with an annular shape in elevation view, which serves as a grip portion, is provided at an outer periphery region of the steering wheel 10. Three spoke sections 10C that serve as connecting portions are provided between the boss portion 10A and the rim section 10B. The spoke sections 10C protrude to the vehicle left side, vehicle right side and lower side from the boss portion 10A, and connect the boss portion 10A with the rim section 10B.

A core 12 fabricated of metal that serves as a framework member is provided at the steering wheel 10.

A boss core 12A in a plate shape is provided at a central region of the core 12. The boss core 12A structures the boss portion 10A. The boss core 12A is fixed to a vehicle rear side end (upper side end) of a circular rod-shaped steering shaft 14 of the vehicle, which serves as a support portion. The steering shaft 14 is disposed to be concentric with the rim section 10B. The steering wheel 10 (the core 12) is supported at the steering shaft 14 to be turnable integrally therewith. When the vehicle occupant holds the rim section 10B and operates to turn the steering wheel 10 in the circumferential direction thereof, the steering shaft 14 turns about the central axis thereof and the vehicle is steered.

A rim core 12B with an annular shape in elevation view is provided at an outer periphery region of the core 12. The rim core 12B structures the rim section 10B. Three spoke cores 12C in plate shapes are provided between the boss core 12A and the rim core 12B. The spoke cores 12C protrude from the boss core 12A to the vehicle left side, vehicle right side and lower side (to outer sides in the radial direction of the steering wheel 10). The spoke cores 12C connect the boss core 12A with the rim core 12B, and structure the spoke sections 10C.

A substantially box-shaped cover 16 fabricated of resin that serves as an accommodation member is provided at the boss portion 10A and the spoke sections 10C. The cover 16 is formed substantially in a “T” shape in an elevation view seen from the vehicle rear side. The interior of the cover 16 is open to the vehicle front side. The cover 16 is attached to the vehicle rear side of the boss core 12A and the spoke cores 12C. The cover 16 covers the vehicle rear side of the boss core 12A and regions of the spoke cores 12C extending to vicinities of the rim section 10B.

A covered member 18 with an annular shape in front view that serves as a fixed member is provided at the whole of the rim section 10B in a length direction of the rim section 10B (the circumferential direction of the steering wheel 10) and a perimeter direction of the rim section 10B (a direction encircling the length direction). The covered member 18 is fabricated of a soft resin (for example, polyurethane). An exterior shape of the covered member 18 in a cross section orthogonal to the length direction is a substantially circular shape. The rim core 12B is accommodated inside the covered member 18, and the covered member 18 is fixed to the rim core 12B.

Protruding rods 18A in substantially rectangular rod shapes are integrally formed at a vehicle right side end portion, a vehicle left side end portion and a lower end portion of the covered member 18. Each protruding rod 18A projects to the radial direction inner side of the steering wheel 10. Regions of the spoke cores 12C in vicinities of the rim core 12B are accommodated in the protruding rods 18A. The protruding rods 18A are fixed to the spoke cores 12C and structure regions of the spoke sections 10C in vicinities of the rim section 10B.

Decorative bodies 20 are disposed at the vehicle left side and vehicle right side of the covered member 18, excluding an upper portion and a lower end portion of the covered member 18.

A garnish 22 in a long, narrow plate shape that serves as a decorative member is provided at each decorative body 20. The garnish 22 is fixed to the rim section 10B at the radial direction inner side of the steering wheel 10 (the side of the rim section 10B at which the steering shaft 14 is disposed) and the vehicle rear side of the rim section 10B. The garnish 22 is curved in a length direction and a width direction thereof. The length direction of the garnish 22 is arranged along the length direction of the rim section 10B, and the width direction of the garnish 22 is arranged along the perimeter direction of the rim section 10B. The garnish 22 is tightly fitted to a recess portion of the covered member 18, and a facing side surface of the garnish 22 is coplanar with a periphery surface of the covered member 18. Thus, the garnish 22 structures the rim section 10B.

Projection portions 22A in plate shapes that serve as connecting portions are integrally formed at upper portion vicinities of the garnishes 22. The projection portions 22A project to the radial direction inner side of the steering wheel 10. The projection portions 22A at the vehicle left side and the vehicle right side cover the vehicle rear side of the protruding rods 18A at, respectively, the vehicle left side and the vehicle right side. The projection portions 22A at the vehicle left side and the vehicle right side structure regions of the spoke sections 10C at, respectively, the vehicle left side and the vehicle right side in vicinities of the rim section 10B. A distal end face of the projection portion 22A at the vehicle left side tightly fits to a vehicle left side end portion of the cover 16, and a distal end face of the projection portion 22A at the vehicle right side tightly fits to a vehicle right side end portion of the cover 16.

Protrusion portions 22B in plate shapes that serve as connecting portions are integrally formed at lower portion vicinities of the garnishes 22. The protrusion portions 22B project to the upper side. The protrusion portions 22B at the vehicle left side and the vehicle right side cover the vehicle rear side of the protruding rod 18A at the lower side. The protrusion portions 22B at the vehicle left side and vehicle right side structure regions of the spoke section 10C at the lower side in vicinities of the rim section 10B. A vehicle right side end face of the protrusion portion 22B at the vehicle left side tightly fits to a vehicle left side face of the lower end portion of the cover 16, and a vehicle left side end face of the protrusion portion 22B at the vehicle right side tightly fits to a vehicle right side face of the lower end portion of the cover 16.

The facing side surface (vehicle rear side face) of each garnish 22 (including the projection portion 22A and protrusion portion 22B) is structured with a decorative layer 22C that serves as a decorative portion (an induction portion). The decorative layer 22C is formed with, for example, a wood grain pattern and decorates the steering wheel 10.

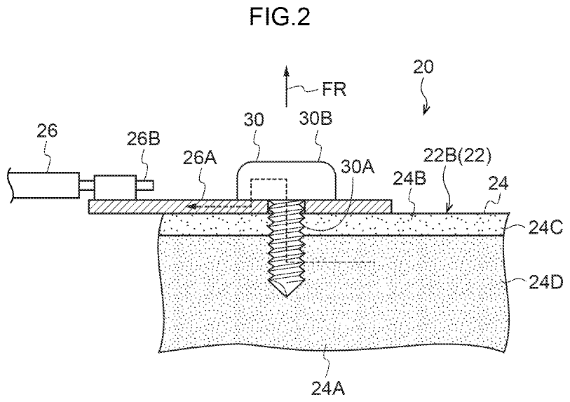

A conductive resin 24 that serves as a sensing portion (see FIG. 2) is provided at the garnish 22 (including the projection portion 22A and protrusion portion 22B) at a back side of the decorative layer 22C. The conductive resin 24 structures end faces and a back side face (vehicle front side face) of the garnish 22. A resin 24B into which a conductive material 24A with conductivity (for example, fibrous carbon fibers) is mixed is injection-molded with a die to form the conductive resin 24. In the whole of a periphery portion of the conductive resin 24 (including all periphery surfaces), a mix density of the conductive material 24A is reduced to form a skin layer 24C that serves as a periphery portion (a low mix portion). The conductive resin 24 is conductive because of the conductive material 24A. In the skin layer 24C, the mix density of the conductive material 24A is lowered and the conductivity is lowered. An inside portion 24D that serves as a conductive portion (a high mix portion) is formed in an inner side region of the conductive resin 24 relative to the skin layer 24C. In the inside portion 24D, the mix density of the conductive material 24A is raised and the conductivity is raised. The conductive resin 24 senses electrostatic capacitance with a hand of a vehicle occupant touching the facing side surface of the garnish 22 (including the projection portion 22A and protrusion portion 22B). Thus, the conductive resin 24 enables detection of touches of the garnish 22 (including the projection portion 22A and protrusion portion 22B) by the hand of the vehicle occupant.

The conductive resins 24 are electronically connected to a control circuit board 28 that serves as a control section, via harnesses 26 that serve as wiring, in regions of the protrusion portions 22B of the garnishes 22. The harnesses 26 are routed at the vehicle rear side of the spoke core 12C and the vehicle rear side of the boss core 12A. The vehicle rear sides of the harnesses 26 are covered by the protrusion portions 22B of the garnishes 22 and the cover 16. The control circuit board 28 is fixed to the vehicle rear side of the boss core 12A, and the vehicle rear side of the control circuit board 28 is covered by the cover 16.

As illustrated in FIG. 2, a plate-shaped terminal 26A fabricated of metal is provided at one end portion of each harness 26 (the end portion at the side of the harness at which the garnish 22 is disposed). The terminal 26A is fixed to and conducts current to a conductive core material 26B of the harness 26. The terminal 26A is fixed to a periphery surface (in the present exemplary embodiment the back side face, which is the vehicle front side face) of the conductive resin 24 by a self-tapping screw 30 fabricated of metal that serves as a conductive member. A thread portion 30A of the self-tapping screw 30 penetrates through the terminal 26A and is inserted and screwed into the conductive resin 24. A head portion 30B of the self-tapping screw 30 sandwiches the terminal 26A between the head portion 30B and the periphery surface of the conductive resin 24. The thread portion 30A penetrates through the skin layer 24C of the conductive resin 24 and is inserted to reach the inside portion 24D of the conductive resin 24. When the thread portion 30A is inserted into the conductive resin 24, the thread portion 30A cuts into the skin layer 24C and the inside portion 24D, removing the skin layer 24C and conducting current to the inside portion 24D. Consequently, the terminal 26A and the inside portion 24D can conduct current via the self-tapping screw 30 (the head portion 30B and the thread portion 30A).

Now, operation of the present exemplary embodiment is described.

In the steering wheel 10 with the structure described above, the conductive resin 24 of each garnish 22 (including the projection portion 22A and protrusion portion 22B) and the control circuit board 28 are electronically connected via the harness 26. Thus, the control circuit board 28 detects gripping of the rim section 10B by a vehicle occupant on the basis of when an electrostatic capacitance between the garnish 22 (including the projection portion 22A and protrusion portion 22B) and the conductive resin 24 is at least a predetermined electrostatic capacitance.

The terminal 26A of the harness 26 is nipped between the head portion 30B of the self-tapping screw 30 and the periphery surface of the conductive resin 24. The thread portion 30A of the self-tapping screw 30 penetrates through the skin layer 24C of the conductive resin 24 and is inserted to reach the inside portion 24D of the conductive resin 24. Consequently, in the state in which the skin layer 24C is removed in the portion where the thread portion 30A penetrates, the thread portion 30A can conduct current to the inside portion 24D. Thus, the terminal 26A of the harness 26 may conduct current via the self-tapping screw 30 to the inside portion 24D with high conductivity (with a high mix density of the conductive material 24A) of the conductive resin 24, the harness 26 may conduct current to more of the conductive material 24A, and conductivity from the harness 26 to the conductive resin 24 may be improved.

When the terminal 26A of the harness 26 is being fixed to the conductive resin 24 by the self-tapping screw 30, the thread portion 30A of the self-tapping screw 30 is inserted into the conductive resin 24 (the skin layer 24C and the inside portion 24D). Thus, the thread portion 30A cuts into the skin layer 24C and the inside portion 24D, removes the skin layer 24C, and can conduct current to the inside portion 24D. Therefore, the skin layer 24C may be removed by the fixing of the terminal 26A of the harness 26 to the conductive resin 24 (by the insertion of the thread portion 30A into the conductive resin 24), and the harness 26 may conduct current to the inside portion 24D. Thus, the harness 26 may conduct current to the inside portion 24D easily. In addition, the need for a task to remove the skin layer 24C separately from a task to allow conduction of current from the harness 26 to the inside portion 24D may be eliminated, and a work cost for removing the skin layer 24C of the conductive resin 24 may be reduced.

The protrusion portion 22B of each garnish 22 is disposed in a connection region between the spoke section 10C at the lower side and the rim section 10B, and the terminal 26A of the harness 26 conducts current with the self-tapping screw 30 to the conductive resin 24 in the protrusion portion 22B. Therefore, the harness 26 may easily be routed to the side at which the spoke section 10C at the lower side is disposed, and may be easily routed to the control circuit board 28 at the boss portion 10A.

In the present exemplary embodiment, the terminal 26A of each harness 26 is formed in, for example, a corrugated plate shape. The terminal 26A is nipped between the head portion 30B of the self-tapping screw 30 and the periphery surface of the conductive resin 24, and the terminal 26A may be resiliently deformed. Further in the present exemplary embodiment, an annular resilient member fabricated of metal (for example, a corrugated plate-shaped washer) may be disposed between the head portion 30B of the self-tapping screw 30 and the terminal 26A of the harness 26. Thus, the terminal 26A and the resilient member are nipped between the head portion 30B and the periphery surface of the conductive resin 24, and the resilient member may be resiliently deformed. In these structures, the terminal 26A conducts current to the conductive resin 24 (the inside portion 24D) in opposition to an urging force of the terminal 26A or the resilient member. Therefore, even if the conductive resin 24 is deformed by heat or the like, or the threading engagement of the thread portion 30A of the self-tapping screw 30 with the conductive resin 24 loosens, conduction from the harness 26 to the conductive resin 24 (the inside portion 24D) may be preserved by the urging force of the terminal 26A or resilient member.

In the present exemplary embodiment, by being inserted into the conductive resin 24, the self-tapping screw 30 removes the skin layer 24C of the conductive resin 24 and allows the harness 26 (the terminal 26A) to conduct current to the inside portion 24D of the conductive resin 24. Alternatively, a pin that has no thread shape, serving as the conductive member, may be inserted into the conductive resin 24 and thus may remove the skin layer 24C of the conductive resin 24 and allow the harness 26 (the terminal 26A) to conduct current to the inside portion 24D of the conductive resin 24.

In the present exemplary embodiment, the thread portion 30A of the self-tapping screw 30 removes the skin layer 24C of the conductive resin 24 and allows the harness 26 (the terminal 26A) to conduct current to the inside portion 24D of the conductive resin 24. Alternatively, the skin layer 24C of the conductive resin 24 may be removed by post-processing independent of the self-tapping screw 30, allowing the harness 26 (the terminal 26A) to conduct current to the inside portion 24D of the conductive resin 24. Further, a hole may be formed in the conductive resin 24 by post-processing, and a screw that is not a self-tapping screw may be used to allow the harness 26 (the terminal 26A) to conduct current to the inside portion 24D of the conductive resin 24.

In the present exemplary embodiment, the harness 26 (the terminal 26A) conducts current to the inside portion 24D of the conductive resin 24 in the protrusion portion 22B of the garnish 22, and the harness 26 is routed at the spoke section 10C at the lower side. Alternatively, the harness 26 (the terminal 26A) may conduct current to the inner side portion 24D of the conductive resin 24 in the projection portion 22A of the garnish 22, and the harness 26 may be routed at the spoke section 10C at the vehicle left side or vehicle right side.

The disclosures of Japanese Patent Application No. 2021-123640 filed Jul. 28, 2021 are incorporated into the present Description by reference in their entirety.

### EXPLANATION OF THE REFERENCE SYMBOLS

10, steering wheel (steering apparatus); 10B, rim section (grip portion); 10C, spoke section (connecting portion); 20, decorative body; 22, garnish (decorative member); 24, conductive resin; 24A, conductive material; 24B, resin; 24C, skin layer (periphery portion); 24D, inside portion (conductive portion); 26, harness (wiring); 30, self-tapping screw.

1. A decorative body comprising:
a decorative member provided at a steering apparatus of a vehicle, the decorative member decorating the steering apparatus;
a conductive resin provided at the decorative member, the conductive resin being structured by molding of a resin into which a conductive material is mixed, and the conductive resin configured to sense a touch of a vehicle occupant against the decorative member; and
a conductive portion provided at an inner side relative to a periphery portion of the conductive resin, the conductive portion conducting current from wiring in a state in which the periphery portion of the conductive resin is removed.

2. The decorative body according to claim 1, further comprising a conductive member that
is inserted into the conductive resin,
removes the periphery portion of the conductive resin, and
allows the wiring to conduct current to the conductive portion.

3. The decorative body according to claim 2, wherein the conductive member is screwed into the conductive resin for removing the periphery portion of the conductive resin and allowing the wiring to conduct current to the conductive portion.

4. The decorative body according to claim 1, wherein:
the steering apparatus includes
a grip portion to be gripped by the vehicle occupant and
a connecting portion that is connected to the grip portion, and
the wiring is configured to conduct current to the conductive portion in a connection region between the grip portion and the connecting portion.

5. The decorative body according to claim 4, wherein the wiring is configured to conduct current to the conductive portion at a projecting portion of the conductive resin, the projecting portion projecting from the grip portion to the side thereof at which the connecting portion is disposed.

6. The decorative body according to claim 1, wherein the wiring is configured to conduct current to the conductive portion in opposition to an urging force.

7. The decorative body according to claim 6, wherein a terminal of the wiring is resiliently deformed.

8. The decorative body according to claim 6, further comprising a resilient member that applies the urging force.
